(19) United States
(12) Patent Application Publication
(10) Pub. No.: US 2011/0320367 A1
(43) Pub. Date: Dec. 29, 2011

(54) Method to Appraise a Patent Asset and a System to Recommend Action to Owner

(75) Inventors: Teresa C. Kan, Rochester, MN (US); Ruthie D. Lyle, Durham, NC (US); Farrokh E. Pourmirzaie, San Jose, CA (US)

(73) Assignee: INTERNATIONAL BUSINESS MACHINES CORPORATION, Armonk, NY (US)

(21) Appl. No.: 12/823,151

(22) Filed: Jun. 25, 2010

(51) Int. Cl. G06Q 99/00

(52) U.S. Cl. 705/306

(57) ABSTRACT

A method for appraising patent includes: determining a set of static factors and a set of dynamic factors for evaluating a set of patents; determining a vector of weighted values for the set of static factors and the set of dynamic factors for each patent in the set of patents; determining a value score for each patent from the vector of weighted values for the static factors and the dynamic factors determined for the patent; receiving a request for a recommended action on one or more patents of the set of patents, where the request comprises parameters for the recommended action, where the parameters comprise the value scores determined for the one or more patents; searching for the one or more patents satisfying the parameters; and returning a list of patents found. The vector of weighted values may be determined based on information collected from internal sources and external sources.

### BACKGROUND

The business world has recognized that the intangible assets of a company may be of substantial value. Such intangible assets may include issued patents. The appraisal of patents may be necessary for accounting, tax, licensing, assignment, litigation, and/or other transactional purposes. Examples of these types of transactions include divorce actions, bankruptcy actions, estate settlements, sales of businesses, and company mergers. The appraisal of intellectual property may also be important for regulatory and financial reporting purposes.

It is commonly known that not every patent has value. Some patents may be very valuable, generating revenue for its owner, while many may have very little value. Because patents may be quite complex, the appraisal of patents is usually a highly detailed and expensive process that requires the input of lawyers, subject matter experts and advisers with specific technical knowledge and experience. The identification of patents that may be valuable, and also those that have little value, is an important goal in the evaluation of any intellectual property portfolio. Despite the recognized value of patents, existing methods to value them involve labor and fact intensive micro-economic analyses.

### BRIEF SUMMARY

According to one embodiment of the present invention, a computer implemented method to appraise patents, comprises: determining a set of factors for evaluating a set of patents; determining a vector of weighted values for the set of factors for each patent in the set of patents; and determining a value score for each patent from the vector of weighted values for the factors determined for the patent.

In an aspect of the present invention, the method further comprises: receiving a request for a recommended action on one or more patents of the set of patents; determining the recommended action for the one or more patents using the value scores determined for the one or more patents; and returning the recommended action for the one or more patents.

In an aspect of the present invention, the request comprises parameters for the recommended action, wherein the parameters comprises the value scores determined for the one or more patents, wherein the determining the recommended action for the one or more patents using the value scores determined for the one or more patents comprises: searching for the one or more patents satisfying the parameters, wherein the returning the recommended action for the one or more patents comprises: returning a list of the patents found.

In an aspect of the present invention, the determining the set of factors for evaluating the set of patents comprises: determining a set of static factors and a set of dynamic factors for evaluating the set of patents, the dynamic factors comprise factors that affect values of the set of patents indirectly and that change over time.

In an aspect of the present invention, the determining the vector of weighted values for the set of factors for each patent in the set of patents comprises: collecting information for each static factor and each dynamic factor from an internal source and an external source; determining a weighted value for each static factor and each dynamic factor based on the collected information; and determining a vector of the weighted values for the static factors and the dynamic factors for each patent in the set of patents.

In an aspect of the present invention, the determining the value score for each patent from the vector of weighted values for the dynamic factors determined for the patent comprises: calculating the value score for each patent from the vector of weighted values for the static factors and the dynamic factors determined for the patent.

In an aspect of the present invention, the determining the set of factors for evaluating the set of patents further comprises: determining one or more additional static factors or dynamic factors for evaluating the set of patents.

In an aspect of the present invention, the returning the list of patents found comprises: returning a prioritized list of the patents found based on the value scores of the patents found.

System and computer program products corresponding to the above-summarized methods are also described and claimed herein.

### BRIEF DESCRIPTION OF THE SEVERAL VIEWS OF THE DRAWINGS

FIG. 1 illustrates an embodiment of a system implementing the method of the present invention.

FIG. 2 is a flowchart illustrating an embodiment of the method of the present invention.

FIG. 3 is a flowchart illustrating in more detail the embodiment of the method of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

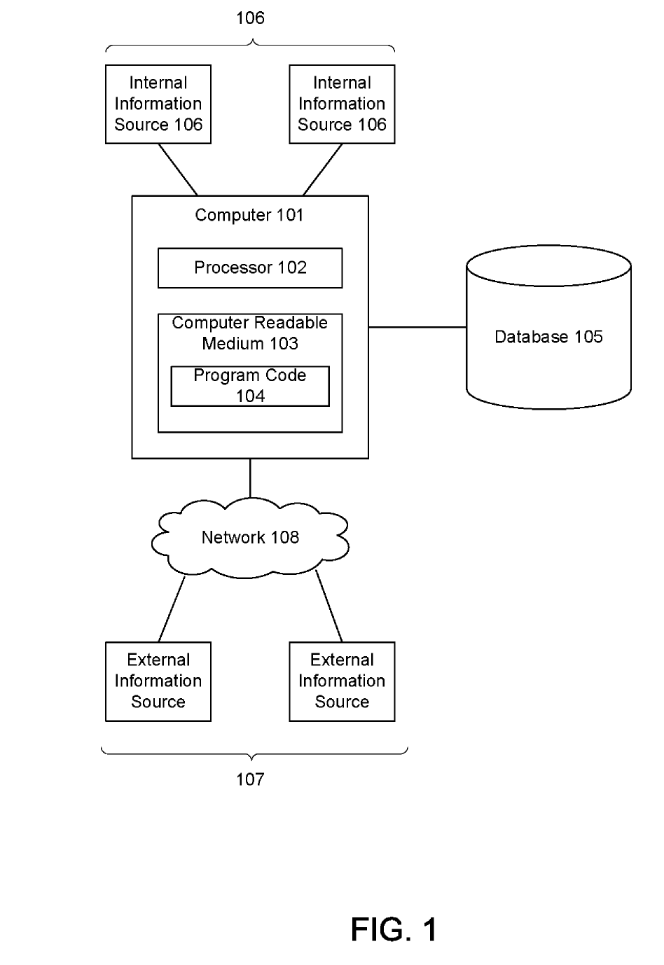

FIG. 1 illustrates an embodiment of a system implementing the method of the present invention. The system includes a computer 101 operationally coupled to a processor 102 and a computer readable medium 103. The computer readable medium 103 stores computer readable program code 104 for implementing the method of the present invention. The processor 102 executes the program code 104 to appraise patents according to the various embodiments of the present invention. The computer 101 is further operationally coupled to a database 105 storing information used in the appraisal of the patents. The information may be obtained by the computer 101 from various internal information sources 106. The computer 101 further has the capability to access information sources 107 external to the system via a network 108, such as the Internet. Information may also be obtained through manual input from a user (not shown).

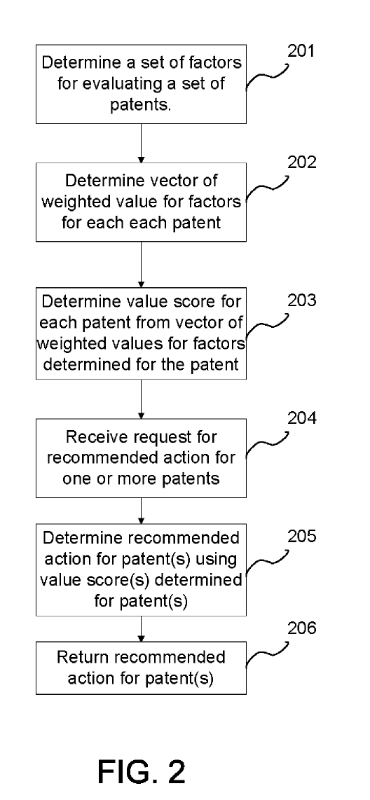

FIG. 2 is a flowchart illustrating an embodiment of the method of the present invention. The method determines a set of factors for evaluating a set of patents (201), comprising one or more issued patents. In this embodiment, the factors include dynamic factors that affect the value of a patent indirectly and that may change over time. Examples of dynamic such factors relevant to the patented product or technology include but are not limited to: associated products' economic performance in the market; number of end users; revenue realized; profitability; popularity; current market conditions; current economic conditions; ferocity of competition; favorability of government regulations; import/export laws; taxes; industry trends; “buzz”; and customer information, such as demographics.

For each patent in the set, the method determines a vector of weighted values for the factors (202). In this embodiment, each factor may be associated with one of a plurality of possible values and a relative importance (weight) between the values and between factors. For example, a patent in the cellular phone industry that enhances the usability of a phone may have a higher value based on its popularity rather than its technology advancement. The plurality of possible values and their relative weights may be customized and updated, depending on the needs of the patent owner. The factors may be applied to a whole portfolio of patents or a subset of the portfolio. The same relative weights for a factor may be used across each patent in a portfolio or different relative weights may be associated for different subsets of the portfolio.

A value score of each patent is determined from the vector of weighted values for the factors determined for the patent (203). A pre-defined formula for the transformation of the vector of weighted values to a value score may be applied. Since the factors may change over time, the value for each weighted factor may be periodically updated and the value scores recomputed. The recomputation may occur when new factors are added or the weights for the factors change. The method may then return the computed, or recomputed, value scores for one or more of the patents.

At some point in time, a request for a recommended action on one or more of the patents is received (204). In response to receiving the request, the method determines the recommended action for the patent(s) using the value score(s) for the patent(s) (205). The recommended action for the patent(s) is returned (206). The list can be prioritized based on value scoring of one or more patents. Similarly, the user can selectively view subsets of the list based on value scores as well. For example, one or more of the patents in the set may be ranked according to their respective value scores. A certain action may then be recommended for one or more of the patents based on where in the ranking the patent resides. For another example, the patents are filtered based on the value scores and an action is recommended for the filtered patents. The filter based on the value scores may be further defined in combination with other factors, such as the value of a dynamic factor itself, or some other characteristic of the patents, such the remaining length of the patent term or the scope of the claims.

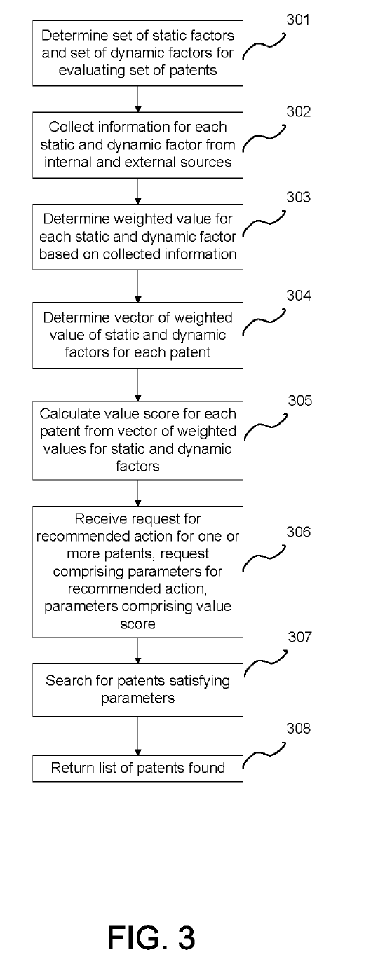

FIG. 3 is a flowchart illustrating in more detail the embodiment of the method of the present invention. In this embodiment, the method is provided through a software tool implemented by the computer 101. The tool determines a set of static factors and a set of dynamic factors for evaluating a set of patents (301). In this embodiment, the tool obtains the static and dynamic factors from the database 105. Static factors are factors that either does not change over time or which impacts the value of a patent directly. Example static factors include but are not limited to: whether the patent asset is still in force; remaining length of the patent term; number of claims; patent claim scope; competing technologies; related patents; multi-jurisdictional filings; prior royalties received from patent; ease of discoverability of infringement of patent; context of valuation (e.g. licensing, assignment, litigation, technology exchange, etc.); quality of file history; number of forward and backward references; demand for patented products; due diligence results; current internal ratings; and case law impacts.

For each static and dynamic factor, the tool collects information from the internal sources 106 and the external sources 107 (302). From the internal sources, the tool may obtain information generated or stored within the system and may include information stored in the database 105. From the external sources 107, the tool may obtain information from third parties. Example external sources include but are limited to: USPTO database; federal court reports; economic reports, industry information, market reports, competitive analyses, blogs, and social media.

The weighted value for each static and dynamic factor is determined based on the collected information (303), and a vector of the weighted values for the static and dynamic factors is determined for each patent (304). The vectors of the patents may be stored in the database 105. In this embodiment, a metadata file, in the form of a table, is created with the weighted value for the static or dynamic factor as its columns and a patent vector at each row. The metadata file may be generated automatically, manually, or both. For example, for the enforceability factor, the maintenance fee is either ‘paid’ (current) or ‘unpaid’. The value ‘paid’ is determined to have a higher importance than ‘unpaid’. To reflect this relative weight, a ‘1’ can be used to denote ‘paid’ while ‘0’ can be used to denote ‘unpaid’. For another example, for the remaining term length factor, a longer length can be given a higher number than one of a shorter length to reflect their relative weights. For another example, for the file history factor, an appraiser may review the file history and determine values such as ‘clean’, ‘allowed with amendment’, or ‘allowed after appeal’. The tool may determine the ‘clean’ value to have a weighted value of ‘9’, the ‘allowed with amendment’ to have a weighted value of ‘8’, and the ‘allowed after appeal’ to have a weighted value of ‘7’.

The value score for each patent is calculated from the vector of weighted values for the static and dynamic factors (305). For example, a formula of V1=f(c1*W1)+f(C2*W2)+ . . . and/or V2=g(C1*W1)*g(Ci*Wi)*V1 may be applied to calculate the value score for each patent. Since the value score can change over time, the vectors, and thus the value scores, may be periodically updated or recalculated. The tool may automatically update the information collected for the static or dynamic factors by accessing the internal 106 or external sources 107, and in response to this update, recalculate the weighted values for the factors and the value scores for the patents. Additional vector components may be added to the formula to facilitate the inclusion of additional static or dynamic factors which might impact valuation. Thus, the formula is extendable.

At some point in time, the tool receives a request for a recommended action for one or more patents, where the request comprises parameters for the recommended action and where the parameters comprise the value score (306). The request parameters may be input by a user of the tool and include a filter based partly or wholly on the value scores of the patents. The parameters may comprise a combination of the value scores with the value for any of the static or dynamic factors, or in combination with any other characteristic available for the patents. For example, the request parameters for a recommended ‘do not pay maintenance fee’ action may be for patents with a value score under X, a remaining patent term length of Y years or less, and a weighted popularity factor value below Z. Other examples include: request parameters for a recommended ‘remove from licensing program’ action include patents whose value scores have dropped by greater than X % in the last 12 months; request parameters for a ‘put up for sale’ action include patents with a value score between X and Y; and request parameters for a recommended ‘file continuations or continuation-in-parts’ action include patents with a value score above X and which has a pending continuation claiming priority to the patent. In another example, the request parameters for a recommended ‘pay award to inventors’ action may be for patents with a value score above X, revenue from the patented product has reached or exceeded Y, and the patent has a remaining patent term of Z years or more.

The tool searches for the patents satisfying the parameters (307) and returns a list of the patents found (308). In this embodiment, the request parameters may be saved by the tool for repeated use.

In one embodiment, a dollar value may be associated with each value score point. For example, one score point=$10,000. Thus, the tool may be used by an appraiser to make dollar value determinations for the portfolio or a subset of the portfolio of patents.

In another embodiment, the tool automatically runs pre-defined searches. The searches may be performed at certain intervals or may be triggered by certain events. For example, if the value scores of a patent or set of patents drops below a threshold, an alert may be sent to a designated appraiser with a recommended action to abandon. In another example, whenever a new factor is added, the searches are automatically run by the tool with the results being made available to the designated appraiser.

In another embodiment, the output of the tool automatically becomes the input to another software process, such as a budgeting process, or the input of another process automatically becomes the input to the tool, such as a subscription-based industry report service. The tool may be configured to automatically run certain searches when such inputs are received.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A computer implemented method to appraise patents, comprising:
determining a set of factors for evaluating a set of patents;
determining a vector of weighted values for the set of factors for each patent in the set of patents; and
determining a value score for each patent from the vector of weighted values for the factors determined for the patent.

2. The method of claim 1, further comprising:
receiving a request for a recommended action on one or more patents of the set of patents;
determining the recommended action for the one or more patents using the value scores determined for the one or more patents; and
returning the recommended action for the one or more patents.

3. The method of claim 2, wherein the request comprises parameters for the recommended action, wherein the parameters comprises the value scores determined for the one or more patents,
wherein the determining the recommended action for the one or more patents using the value scores determined for the one or more patents comprises: searching for the one or more patents satisfying the parameters,
wherein the returning the recommended action for the one or more patents comprises: returning a list of the patents found.

4. The method of claim 1, wherein the determining the set of factors for evaluating the set of patents comprises:
determining a set of static factors and a set of dynamic factors for evaluating the set of patents, the dynamic factors comprise factors that affect values of the set of patents indirectly and that change over time.

5. The method of claim 4, wherein the determining the vector of weighted values for the set of factors for each patent in the set of patents comprises:
collecting information for each static factor and each dynamic factor from an internal source and an external source;
determining a weighted value for each static factor and each dynamic factor based on the collected information; and
determining a vector of the weighted values for the static factors and the dynamic factors for each patent in the set of patents.

6. The method of claim 5, wherein the determining the value score for each patent from the vector of weighted values for the factors determined for the patent comprises:
calculating the value score for each patent from the vector of weighted values for the static factors and the dynamic factors determined for the patent.

7. The method of claim 4, wherein the determining the set of factors for evaluating the set of patents further comprises:
determining one or more additional static factors or dynamic factors for evaluating the set of patents.

8. The method of claim 2, wherein the returning the list of the patents found comprises:
returning a prioritized list of the patents found based on the value scores of the patents found.

9. A computer program product to appraise patents, the computer program product comprising:
a computer readable storage medium having computer readable program code embodied therewith, the computer readable program code comprising:
determine a set of factors for evaluating a set of patents;
determine a vector of weighted values for the set of factors for each patent in the set of patents; and
determine a value score for each patent from the vector of weighted values for the factors determined for the patent.

10. The computer program product of claim 9, wherein the computer readable program code is further comprising of:
receive a request for a recommended action on one or more patents of the set of patents;
determine the recommended action for the one or more patents using the value scores determined for the one or more patents; and
return the recommended action for the one or more patents.

11. The computer program product of claim 10, wherein the request comprises parameters for the recommended action, wherein the parameters comprises the value scores determined for the one or more patents,
wherein the wherein the computer readable program code determine the recommended action for the one or more patents using the value scores determined for the one or more patents is further comprising of: search for the one or more patents satisfying the parameters,
wherein the computer readable program code return the recommended action for the one or more patents is further comprising of: return a list of the patents found.

12. The computer program product of claim 9, wherein the computer readable program code determine the set of factors for evaluating the set of patents is further comprising of:
determine a set of static factors and a set of dynamic factors for evaluating the set of patents, the dynamic factors comprise factors that affect values of the set of patents indirectly and that change over time.

13. The computer program product of claim 12, wherein the computer readable program code determine the vector of weighted values for the set of factors for each patent in the set of patents is further comprising of:
collect information for each static factor and each dynamic factor from an internal source and an external source;
determine a weighted value for each static factor and each dynamic factor based on the collected information; and
determine a vector of the weighted values for the static factors and the dynamic factors for each patent in the set of patents.

14. The computer program product of claim 13, wherein the computer readable program code determine the value score for each patent from the vector of weighted values for the factors determined for the patent is further comprising of:
calculate the value score for each patent from the vector of weighted values for the static factors and the dynamic factors determined for the patent.

15. The computer program product of claim 12, wherein the computer readable program code determine the set of factors for evaluating the set of patents further is further comprising of:
determine one or more additional static factors or dynamic factors for evaluating the set of patents.

16. The computer program product of claim 11, wherein the computer readable program code return the list of the patents found is further comprising of:
return a prioritized list of the patents found based on the value scores of the patents found.

17. A system, comprising:
a computer comprising a computer readable storage medium having computer readable program code embodied therewith, the computer readable program code comprising:
determine a set of factors for evaluating a set of patents;
determine a vector of weighted values for the set of factors for each patent in the set of patents; and
determine a value score for each patent from the vector of weighted values for the factors determined for the patent.

18. The system of claim 17, wherein the computer readable program code is further comprising of:
receive a request for a recommended action on one or more patents of the set of patents;
determine the recommended action for the one or more patents using the value scores determined for the one or more patents; and
return the recommended action for the one or more patents.

19. The system of claim 18, wherein the request comprises parameters for the recommended action, wherein the parameters comprises the value scores determined for the one or more patents,
wherein the wherein the computer readable program code determine the recommended action for the one or more patents using the value scores determined for the one or more patents is further comprising of: search for the one or more patents satisfying the parameters,
wherein the computer readable program code return the recommended action for the one or more patents is further comprising of: return a list of the patents found.

20. The system of claim 17, wherein the computer readable program code determine the set of factors for evaluating the set of patents is further comprising of:
determine a set of static factors and a set of dynamic factors for evaluating the set of patents, the dynamic factors comprise factors that affect values of the set of patents indirectly and that change over time.

21. The system of claim 20, wherein the computer readable program code determine the vector of weighted values for the set of factors for each patent in the set of patents is further comprising of:
collect information for each static factor and each dynamic factor from an internal source and an external source;
determine a weighted value for each static factor and each dynamic factor based on the collected information; and
determine a vector of the weighted values for the static factors and the dynamic factors for each patent in the set of patents.

22. The system of claim 21, wherein the computer readable program code determine the value score for each patent from the vector of weighted values for the factors determined for the patent is further comprising of:
calculate a value score for each patent from the vector of weighted values for the static factors and the dynamic factors determined for the patent.

23. The system of claim 20, wherein the computer readable program code determine the set of factors for evaluating the set of patents is further comprising of:
determine one or more additional static factors or dynamic factors for evaluating the set of patents.

24. A computer implemented method to appraise patents, comprising:
determining a set of static factors and a set of dynamic factors for evaluating a set of patents;
determining a vector of weighted values for the set of static factors and the set of dynamic factors for each patent in the set of patents;
determining a value score for each patent from the vector of weighted values for the static factors and the dynamic factors determined for the patent;
receiving a request for a recommended action on one or more patents of the set of patents, wherein the request comprises parameters for the recommended action, wherein the parameters comprise the value scores determined for the one or more patents;
searching for the one or more patents satisfying the parameters; and
returning a list of patents found.

25. A computer program product to appraise patents, the computer program product comprising:
a computer readable storage medium having computer readable program code embodied therewith, the computer readable program code comprising:
determine a set of static factors and a set of dynamic factors for evaluating a set of patents;
determine a vector of weighted values for the set of static factors and the set of dynamic factors for each patent in the set of patents;
determine a value score for each patent from the vector of weighted values for the static factors and the dynamic factors determined for the patent;
receive a request for a recommended action on one or more patents of the set of patents, wherein the request comprises parameters for the recommended action, wherein the parameters comprise the value scores determined for the one or more patents;
search for the one or more patents satisfying the parameters; and
return a list of patents found.
